(19) United States
(12) Patent Application Publication
(10) Pub. No.: US 2025/0007427 A1
(43) Pub. Date: Jan. 2, 2025

(54) PIEZOELECTRIC POWER GENERATION FROM PLANT GROWTH

(71) Applicant: Nathaniel Brooks, Juneau, AK (US)

(72) Inventor: Nathaniel Brooks, Juneau, AK (US)

(21) Appl. No.: 18/756,993

(22) Filed: Jun. 27, 2024

Related U.S. Application Data
(60) Provisional application No. 63/511,016, filed on Jun. 29, 2023.

(51) Int. Cl. H02N 2/18

(52) U.S. Cl. CPC H02N 2/18

(57) ABSTRACT

An apparatus and method for harnessing clean energy from botanical growth and activity in plant growth medium. A piezoelectric matrix is deposited in the plant growth medium. The botanical growth and activity exert pressure on the piezoelectric matrix resulting in the generation of electricity.

### CROSS-REFERENCE TO RELATED APPLICATIONS

This application claims priority from a U.S. Provisional Patent Appl. No. 63/511,016, filed on Jun. 29, 2023, which is incorporated herein by reference in its entirety.

### FIELD OF INVENTION

The present invention relates to piezoelectric generation of power, and more particularly, the present invention relates to piezoelectric power generation through plant growth.

### BACKGROUND

Electricity is the lifeline of the modern world. However, most of the electricity produced nowadays is by burning fossil fuels. Burning of fossil fuels in large quantities all around the world has led to a significant increase in global warming. This in turn has led to an increased interest in clean energy sources. Currently, solar, wind, and wave are the most explored renewable energy sources. However, all renewable energy sources suffer from one major limitation i.e., they are not available all the time and not in the same quantity. Hence, it is desirable to explore new sources of clean energy.

### SUMMARY OF THE INVENTION

The following presents a simplified summary of one or more embodiments of the present invention to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to piezoelectric power generation through plant growth, any botanical/biological growth, and other movements from environmental changes over time.

Another object of the present invention is that the power generated can be stored and distributed.

Yet another object of the present invention is that the generated electricity can support electricity demand in agricultural or agriculture related infrastructure.

Still, another object of the present invention is that the invention can be easily implemented.

A further object of the present invention is that the implementation can be cost-effective.

In one aspect, disclosed are an apparatus and method for harnessing and using energy associated with botanical and agricultural growth, and re-introducing the energy into systems to further sustain the growth or used for domestic and industrial consumption.

In one aspect, disclosed is a self-sustaining plant growth system in which energy is harnessed from plant growth using piezoelectric power generation, and the same energy can be used for sustaining the plant growth.

In one aspect, disclosed is an apparatus for harnessing clean energy. The apparatus comprises a housing configured to contain plant growth medium, the housing has one or more holes for a plant to grow; the plant growth medium contained in the housing; and a piezoelectric matrix disposed in the plant growth medium, wherein the piezoelectric matrix is configured to generate electricity in response to pressure exerted by a root system of the plant and changes in the plant growth medium. The plant growth medium comprises soil. The piezoelectric matrix is attached to inner areas of the housing. The piezoelectric matrix is added as blocks in the plant growth medium.

In one aspect, disclosed is a plant growth medium comprising a piezoelectric matrix. The piezoelectric matrix is added as blocks in the plant growth medium.

In one aspect, disclosed is a method for harnessing clean energy, the method comprising adding a plant growth medium in a housing, wherein the housing has one or more holes for a plant to grow; disposing piezoelectric matrix in the plant growth medium, wherein the piezoelectric matrix is configured to generate electricity in response to pressure exerted by a root system of the plant and changes in the plant growth medium; and collecting the generated electricity through a harnessing unit, wherein the harnessing unit is coupled to the piezoelectric matrix using conductors.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a schematic diagram showing the plantation using the disclosed apparatus for piezoelectric power generation, according to an exemplary embodiment of the present invention.

FIG. 2 shows a diagram to explain the piezoelectric power generation from root growth, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

The described invention pertains to an apparatus and method for harnessing energy from botanical/biological growth, including but not limited to plants, fungi, and bacteria that all contribute to the kinetic activities in the plant growth medium, using piezoelectric power generation technology. The present invention can harness the energy from root, fungi, and bacterial growth and changes in the growth medium, including but not limited to changes in humidity/moisture, temperature, light, and seismic activity. The apparatus and method are advantageous in that renewable energy can be continuously harnessed throughout the growth period of any botanical/biological life. The generated power can be used to facilitate the growth of plants and other botanical life. For example, in growing plants, artificial light sources, fans, pumps for hydroponic systems, and the like are used. The harness of renewable energy from the disclosed apparatus and using the disclosed method can be used to power such devices used in growing plants. It is to be noted that the harnessed energy from the disclosed apparatus and using the disclosed method can be stored and used for other purposes, and any suitable use of the harnessed energy is within the scope of the present invention.

Typically, plants are planted in some suitable plant growth medium, such as a soil mix. With time the plant grows including the root system of the plant. The roots expand and enlarge in the plant growth medium for a variety of reasons. Such reasons are out of the scope of the present invention. The expansion and enlargement of the roots in the plant growth medium exert pressure on the growth medium. Also, there is microbial growth in the plant growth medium which imparts kinetic activity as well as compression in the plant growth medium. The microbes also manipulate the constitution of the plant growth medium over time, which also results in a change in the compressibility of the plant growth medium. Also, organisms, such as snails, and worms, in the soil and like plant growth medium have good kinetic activity which results in a change in compressibility of the plant growth medium.

The described apparatus and method aim to harness such pressure exerted by the expanding and enlarging roots system; microbial growth; microbial kinetic activity; small animal activities; and changes in plant growth medium due to the addition of water, and changes in humidity, and temperature, all collectively referred to herein as force elements. The present invention uses piezoelectric material which can harness the force exercised by the force elements in the plant growth medium. Also, there is continuous movement of the root system not only from growth but from expansion and contraction due to changes in temperature and weather. Watering the plants as well as humidity results in the expansion and contraction of the plant growth medium and the roots.

The apparatus includes a piezoelectric matrix that can be incorporated into the plant growth medium. It may be preferable that the piezoelectric matrix touches the roots, however, directed contact may not be necessary as the pressure is exerted on the growth medium and thus to the piezoelectric matrix disposed in the plant growth medium. The roots as well as changes in plant growth medium exert pressure on the piezoelectric matrix which results in the generation of electricity. The piezoelectric matrix can be flexible, semi-rigid, or rigid. Suitable examples of rigid piezoelectric matrices include quarts, and flexible piezoelectric materials, such as PMDS (polydimethylsiloxane/polypyrrole) composite polymers can be used.

In certain implementations, the changes in the upper plants of the plant, such as shoots can also be harnessed by the disclosed apparatus and method. For example, the apparatus may include a mesh or cage overlaying or covering the plant. Such mesh or cages can be made from piezoelectric material. The shoots while moving, expanding, and/or enlarging can exert pressure on the mesh or cage, resulting in the generation of electrical energy.

In certain implementations, disclosed is a plant growth medium containing the piezoelectric matrix. The plant growth medium may also include other materials, such as soils, minerals, and other nutrients known to a person skilled in the art of plant growth. The piezoelectric matrix may be perforated like a beehive wherein the roots can expand into the perforations. The nutrient media can be deposited in the perforations.

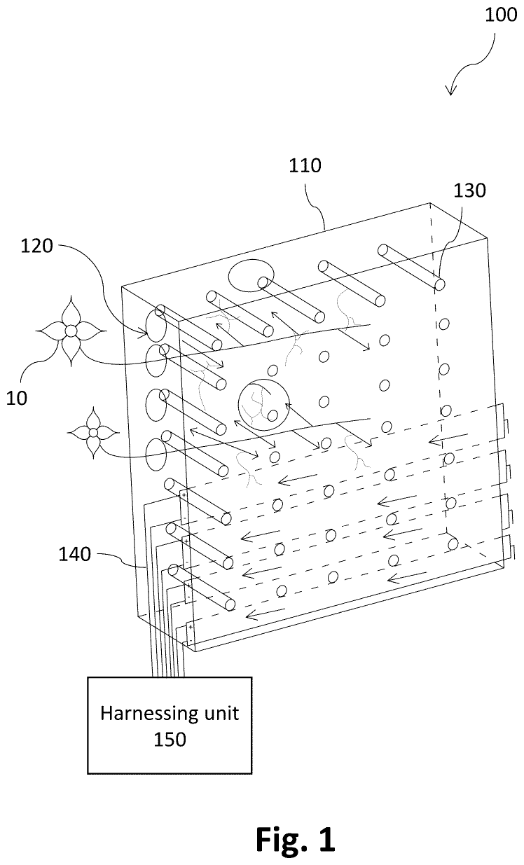

Referring to FIG. 1 shows an apparatus according to an exemplary embodiment of the present invention. The apparatus includes a rack 110 for plantation having multiple rows. The walls of the rack housing have holes 120 resembling a cage and through these holes, the growing plant 10 can protrude. The housing includes containers for containing plant growth medium. The piezoelectric matrix 130 can be disposed on the inner walls of the containers and into the plant growth media. The piezoelectric matrix in the form of rods and blocks can be dispersed in the plant growth medium contained in the containers. The piezoelectric material in the form of blocks and roads can be anchored or fixed to the housing and/or freely dispersed. The changes in root and plant growth medium in the container can exert pressure on the piezoelectric matrix resulting in the generation of electricity. Also, the piezoelectric matrix can be disposed on walls of the housing, at least along the holes in the wall, so that it be in contact with the shoots of the plants. Flexible piezoelectric materials can be used in any plant bedding for harnessing the energy from the root system. Electric wires 140, such as those made of copper, can be used to carry generated electricity from the piezoelectric matrix to a harnessing unit 150. The harnessing unit may include electrical components, such as transformers, amplifiers, controllers, and the like for harnessing the electrical energy and transforming the same to a usable state. The harnessing unit may also include suitable storage units, such as batteries for storing the electrical energy, any type of storage unit is within the scope of the present invention.

In certain implementations, the housing can have a suitable frame, and walls in the form of plates can be attached to the frame. The piezoelectric materials can be attached to these plates.

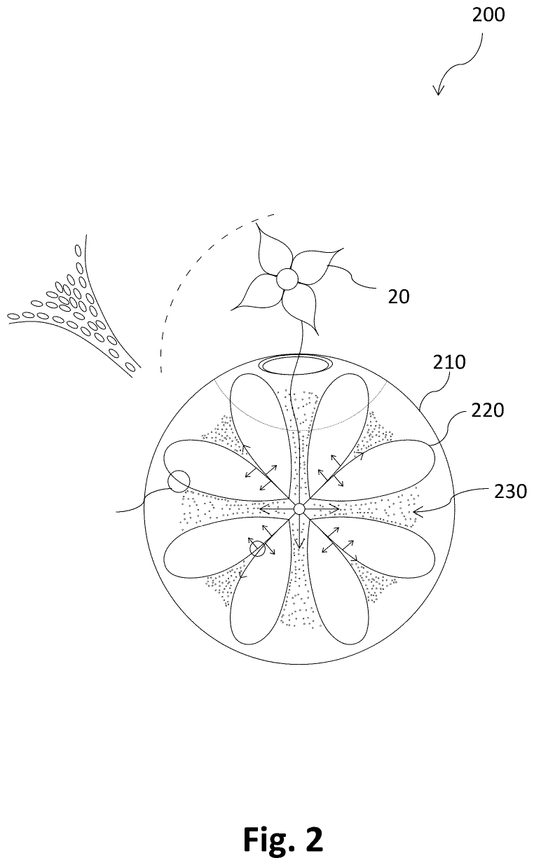

FIG. 2 shows another embodiment of apparatus 200 which is a pot. The pot has an open top for a plant 20 to grow. The pot contains plant growth medium 230 including the piezoelectric matrix 220. The piezoelectric matrix may be perforated which allows the roots to grow and expand into the outer housing for nutrition. The root system can spread through the inner piezoelectric matrix and pass through the perforations to absorb the nutrients and water in the outer housing. The expansion of the root system and mass of the growing medium can exert a continuous pressure or force on the piezoelectric matrix. The pressure or force on the piezoelectric medium results in the generation of electrical energy which can be carried to the harnessing unit through electrical leads. The pot can be made from any suitable material and any such pot is within the scope of the present invention. Also, the size and shape of the pot can be varied without departing from the scope of the present invention. An inner lining/matrix made from PMDS (polydimethylsiloxane/polypyrrole) or other suitable flexible piezoelectric material can be disposed inside the pot. Also, as explained before the force elements in the plant growth medium can exert additional pressure on the piezoelectric medium resulting in the generation of electricity.

In certain implementations, the leads for the static/rigid design can be connected by plates that sandwich the piezoelectric material. In certain implementations, the leads can be attached through the manufacturing process and are built into the material making it one large conductor. For example, flexible piezoelectric materials can have integral leads.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. An apparatus for harnessing clean energy, the apparatus comprising:
a housing configured to contain plant growth medium, the housing has one or more holes for a plant to grow;
the plant growth medium contained in the housing; and
a piezoelectric matrix disposed in the plant growth medium, wherein the piezoelectric matrix is configured to generate electricity in response to pressure exerted by a root system of the plant and changes in the plant growth medium.

2. The apparatus of claim 1, wherein the plant growth medium comprises soil.

3. The apparatus of claim 1, wherein the piezoelectric matrix is attached to inner areas of the housing.

4. The apparatus of claim 3, wherein the piezoelectric matrix is added as blocks in the plant growth medium.

5. A plant growth medium comprising a piezoelectric matrix.

6. The plant growth medium of claim 5, wherein the piezoelectric matrix is added as blocks or grid in the plant growth medium.

7. The plant growth medium of claim 5, wherein the plant growth medium is a soil bed of a yard, field, or forest.

8. A method for harnessing clean energy, the method comprising:
adding a plant growth medium in a housing, wherein the housing has one or more holes for a plant to grow;
disposing piezoelectric matrix in the plant growth medium, wherein the piezoelectric matrix is configured to generate electricity in response to pressure exerted by a root system of the plant and changes in the plant growth medium; and
collecting the generated electricity through a harnessing unit, wherein the harnessing unit is coupled to the piezoelectric matrix using conductors.

9. The method of claim 8, wherein the plant growth medium comprises soil.

10. The method of claim 8, wherein the method further comprises:
attaching the piezoelectric matrix to inner areas of the housing.

11. The method of claim 10, wherein the piezoelectric matrix is added as blocks in the plant growth medium.
